(19) United States
(12) Patent Application Publication
(10) Pub. No.: US 2026/0245471 A1
(43) Pub. Date: Aug. 20, 2026

(54) METHOD AND APPARATUS TO GENERATE DIFFERENTIATED ORAL PROMPTS FOR LEARNING

(71) Applicant: AGENCY FOR SCIENCE, TECHNOLOGY AND RESEARCH, Singapore (SG)

(72) Inventors: Huayun ZHANG, Singapore (SG); Fang Yih Nancy CHEN, Singapore (SG)

(21) Appl. No.: 19/471,270

(22) PCT Filed: Mar. 27, 2024
(86) PCT No.: PCT/SG2024/050180

§ 371 Date: Sep. 30, 2025

(30) Foreign Application Priority Data
Mar. 30, 2023 (SG) 10202300883Q

(51) Int. Cl. G09B 5/06; G10L 13/10; G10L 15/04

(52) U.S. Cl. CPC G09B 5/06; G10L 13/10; G10L 15/04

(57) ABSTRACT

A method and an apparatus for generating one or more differentiated oral prompt for learning, the method comprising: presenting a learning task to a user on a display; receiving user feedback to the learning task; determining a diagnosis input based on the user feedback; performing a diagnosis, using a prompt generation model, on the diagnosis input to generate a differentiated oral prompt and a differentiated speech highlighting mask associated with the differentiated oral prompt, wherein the differentiated speech highlighting mask include data indicative of prosodic control; inputting the differentiated oral prompt and the differentiated speech highlighting mask to a Text-to-Speech module with prosody control to generate speech signals for reading out the differentiated oral prompt with speech highlights specified in the differentiated speech highlighting mask; and converting the speech signals into a format for reading out the differentiated oral prompt with the specified speech highlights through an audio device.

### FIELD

The present invention relates to the field of speech processing, and particularly, a method and an apparatus to convert text to speech. More particularly, the invention relates to a method and an apparatus to generate differentiated oral prompts for learning.

### BACKGROUND

Artificial Intelligent (AI) tutors available today are generally based on behaviorism in pedagogy. Students using such AI tutors are supposed to learn through repetition and reinforcement, wherein the AI tutor provides quick and constant feedback (such as marks/scores) that informs the students whether what they are doing in response to a presented query is right or wrong. However, such approach may disregard student identity and individuality. Therefore, AI tutors are inept in real-time assessment of the student's learning process.

Generally, AI Tutors lack personalized communication, which may result in a student feeling unmotivated because his or her AI tutor (when compared to a human tutor) does not seem to care if him or her succeed or fail. This lack of motivation may cause the student to lose focus on learning. Without addressing the emotional dimension of learning, the learning efficacy of the student would be much lower.

To overcome the abovementioned problem, some AI tutors provide broad help information (text/audio/video) for learners. However, such broad information lacks immediate relevance to the learner's situation. The learners have to make effort to understand the additional information provided, break it down and then try to identify the parts that may help them. Providing learners with loads of information often makes AI assisted learning tedious and rather frustrating.

### SUMMARY

The invention is defined in the independent claims. Some optional features of the invention are defined in the dependent claims.

### BRIEF DESCRIPTION OF DRAWINGS

In the drawings, the same reference numerals generally relate to the same parts throughout different views, unless otherwise specified. Embodiments of the invention will be better understood and readily apparent to one skilled in the art from the following written description, by way of example only and in conjunction with the drawings, in which:

FIG. 1 shows an overview of an AI-assisted learning method according to an example of the present disclosure.

FIG. 2 shows a framework of an AI-assisted learning method to generate a differentiated correction prompt according to an example of the present disclosure.

FIG. 3 shows an example of a differentiated correction prompt generated in response to a learner's input to a learning task.

FIG. 4 illustrates three different use cases for generating a differentiated correction prompt in response to a learner's input to a learning task according to an example of the present disclosure.

FIG. 5 shows a workflow on how a differentiated correction prompt is generated in response to a learner's input to a learning task according to an example of the present disclosure.

FIG. 6 shows how a highlighted speech is generated based on a differentiated correction prompt according to an example of the present disclosure.

FIG. 7 illustrates a system architecture of a learner's apparatus or device according to an example of the present disclosure.

### DETAILED DESCRIPTION

Artificial Intelligence-assisted learning (AI-assisted learning) can be improved by providing a customized oral prompt in response to an input from a user (or a learner) interacting with an AI-assisted learning platform. Examples of the present disclosure provide such improvement.

In face-to-face classes, human tutors would not always use scores/marks or large chunks of raw information to guide their students. Instead, a human tutor will provide concise oral prompts to a specific learner to pinpoint the parts where mistakes occur and/or to draw the attention of the learner to the relevant content to assist them to derive the correct answer. Such oral prompts are ubiquitous in traditional education and proven to be very effective in face-to-face teaching practice. It is a challenge to create an AI tutor, which can provide such oral prompts. Oral prompts in existing AI-assisted learning environment lack expressiveness and are generally standardized for all students.

Examples of the present disclosure proposes a solution to provide an AI tutor to interact with the individual learners in a more effective way. By providing feedback in a humanly manner, learning will be enhanced for the student.

It has been observed that students need motivation beyond results of assessment (scores and numbers) to advance in learning. An AI tutor according to an example of the present disclosure is configured to provide such motivation. For instance, when a student's score is unsatisfactory, the AI tutor is configured to share with the student the assessment results of a learning task and offer words of encouragement and heuristic speech instructions, which may act to trigger the student's understanding and learning.

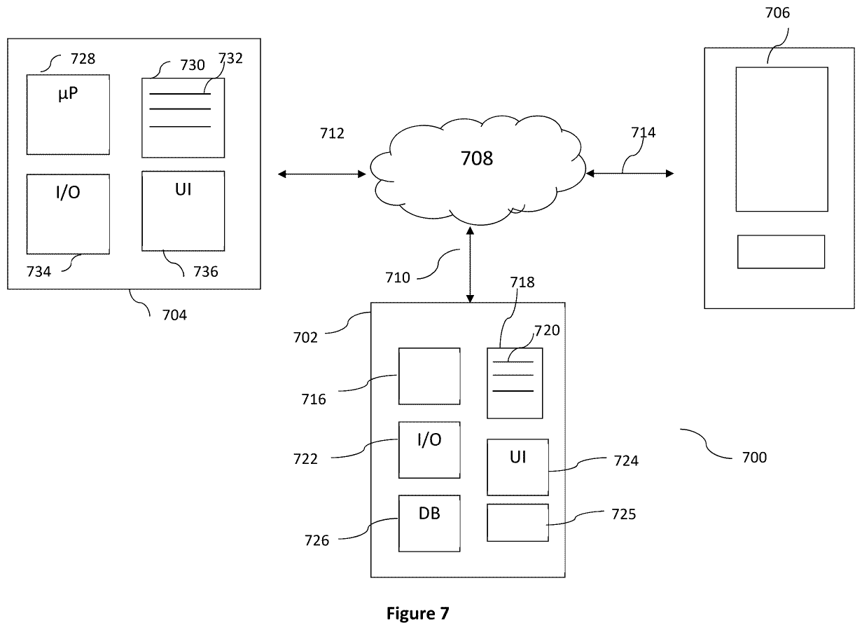

The AI tutor according to an example of the present disclosure may be in the form of an apparatus for facilitating the learning of a student (i.e. a learner apparatus). The learner apparatus can be a computing or mobile device, for example, desktop computer, laptop computer, smart phones, tablet devices, and other handheld devices. The learner apparatus may have the elements of an apparatus 702 shown in FIG. 7. Any image processor, controller or processor mentioned in the present disclosure may also have the same elements as that described and shown for the apparatus 702. One or more of the apparatus 702 may be able to communicate through a communication network 708, such as, a wired or wireless network (e.g. WiFi), mobile telecommunication network and the like.

The apparatus 702 may be a computing device and comprises a number of individual components including, but not limited to, processing unit (or processor) 716, a memory 718 (e.g. a volatile memory such as a Random Access Memory (RAM) for the loading of executable instructions 720, the executable instructions defining the functionality the apparatus 702 carries out under control of the processing unit 716. The apparatus 702 also comprises a network module 725 allowing the apparatus to communicate over the communications network 708 (for example the internet). User interface 724 is provided for user interaction and may comprise, for example, conventional computing peripheral devices such as display monitors, mouse, computer keyboards and the like. The apparatus 702 may also comprise a database 726. It should also be appreciated that the database 726 may not be local to the apparatus 702. The database 726 may be a cloud database, which may comprise data used to assess a learner's learning progress.

The processing unit 716 is connected to input/output devices such as a computer mouse, keyboard/keypad, a display, headphones or microphones, a video camera and the like (not illustrated in Figure) via Input/Output (I/O) interfaces 722. The components of the processing unit 716 typically communicate via an interconnected bus (not illustrated in FIG. 7) and in a manner known to the person skilled in the relevant art.

The processing unit 716 may be connected to the network 708, for instance, the Internet, via a suitable transceiver device (i.e. a network interface) or a suitable wireless transceiver, to enable access to e.g. the Internet or other network systems such as a wired Local Area Network (LAN) or Wide Area Network (WAN). The processing unit 716 of the apparatus 702 may also be connected to one or more external wireless communication enabled remote server 704 and/or other learner device 706 through the respective communication links 710, 712, and 714 via the suitable wireless transceiver device e.g. a WiFi transceiver, Bluetooth module, Mobile telecommunication transceiver suitable for Global System for Mobile Communication (GSM), 3G, 3.5G, 4G, 5G telecommunication systems, or the like.

Instead of the system architecture described above for the computing apparatus 702, the learner apparatus (including the learner device 706) may be a mobile device, for example, smart phones, tablet devices, and other handheld devices, having the system architecture of a remote server 704. In addition, the one or more learner devices 706 may be able to communicate through other communication network, such as, wired or wireless network, mobile telecommunication networks.

The remote server 704 may comprise a number of individual components including, but not limited to, a microprocessor 728, and a memory 730 (e.g. a volatile memory such as a RAM) for the loading of executable instructions 732, the executable instructions defining the functionality the remote server 704 carries out under control of the processor 728. The remote server 704 also comprises a network module (not illustrated in FIG. 7) allowing the remote server 704 to communicate over the communication network 708. User interface 736 is provided for user interaction and control that may be in the form of a touch panel display and presence of a keypad as is prevalent in many smart phone and other handheld devices. The remote server 704 may also be connected to a database (not illustrated in FIG. 7), which may not be local to the remote server 704 but a cloud database. The remote server 704 may include a number of other Input/Output (I/O) interfaces as well but they may be for connection with headphones or microphones or speakers (audio devices), Subscriber identity module (SIM) card, flash memory card, USB based device, and the like.

The software and one or more computer programs installed in the apparatus 702, 704 and/or 706 may include one or more software applications for instant messaging platform, audio/video playback, internet accessibility, operating the apparatus 702, remote server 704 and/or learner device 706 (i.e. operating system), network security, file accessibility, database management etc. The software and one or more computer programs may be supplied to the user of the apparatus 702, remote server 704 or the learner device 706 encoded on a data storage medium such as a CD-ROM, on a flash memory carrier or a Hard Disk Drive, and are to be read using a corresponding data storage medium drive for instance, a data storage device (not illustrated in FIG. 7). Such application programs may also be downloaded from the network 708. The application programs are read and controlled in its execution by the processing unit 716 or microprocessor 728. Intermediate storage of program data may be accomplished using RAM 720 or 730.

Furthermore, one or more of the steps of the computer programs or software may be performed in parallel rather than sequentially. One or more of the computer programs may be stored on any machine or computer readable medium that may be non-transitory in nature. The computer readable medium may include storage devices such as magnetic or optical disks, memory chips, or other storage devices suitable for interfacing with a general-purpose computer or mobile device. The machine or computer readable medium may also include a hard-wired medium such as exemplified in the Internet system, or wireless medium such as exemplified in the Wireless LAN (WLAN) system. The computer program when loaded and executed on such a general-purpose computer effectively results in an apparatus that implements the steps of the computing methods in examples herein described.

In one example, the learner apparatus is configured to, prior to allowing access to learning tasks, determine the identity of a learner based on password-based authentication, multifactor authentication, biometric authentication (such as facial recognition and fingerprint recognition) and the like. After access is allowed, the learner apparatus is configured to allow a learner to access questions/assignments created to meet the learning objectives set for (or set by) the learner. The learner may be allowed to access history of the questions/assignments attempted by the learner.

The learner apparatus may be configured to, based on an input provided by the learner in response to each question (or learning task), generate concise and relevant differentiated instruction (or differentiated response), which can be audio, video and/or text feedback, based on the input. One example of a differentiated response is a compliment given to the learner for getting the answer correct. The compliment may be a differential oral prompt that contains speech modified or manipulated to include acoustic/audio cues to highlight and/or de-emphasize parts of the speech so that, for instance, the compliment sounds more personalized. Another example of a differentiated response is a differentiated correction prompt (or in short “correction prompt”) to guide the learner to the correct answer if the learner's input is deemed as an incorrect, incomplete or insufficient response to the learning task. For instance, the differentiated correction prompt can be a differentiated oral prompt that contains speech modified or manipulated to include acoustic/audio cues to highlight and/or de-emphasize parts of the speech to be read out to the learner. The differentiated oral prompt may include visual cues, which will be elaborated later.

To clarify, in the present disclosure, a differentiated instruction (or differentiated response) refers to a response to a learning task attempted by a learner, which is outputted by the learner apparatus regardless of whether the response is deemed as a correct response to the learning task. A correction prompt or differentiated correction prompt or differentiated helping prompt refers to a response to a learning task attempted by a learner, which is outputted by the learner apparatus if the response is deemed as an incorrect response to the learning task. As discussed in the preceding paragraph, a differentiated correction prompt is a differentiated instruction (or differentiated response), but a differentiated instruction or response may not be a differentiated correction prompt. In the examples of the present disclosure, a differentiated response will result in the generation of an oral prompt or differentiated oral prompt, which refers to an audio output in response to a feedback (or answer) provided by a learner. The term “differentiated” means “tailored” i.e. the differentiated oral prompt is an oral prompt tailored for a user. A final form of oral prompt or differentiated oral prompt to be outputted should contain speech modified or manipulated to include acoustic/audio cues to highlight and/or de-emphasize parts of the text or speech. It should be appreciated that before an oral prompt or differentiated oral prompt is modified or manipulated to include audio cues, it can also be called an oral prompt or differentiated oral prompt as well for the sake of simplicity.

In some examples, the differentiated oral prompt may, exclude reading out the oral prompt to the learner via an audio device, and only include text modified or manipulated to include visual cues that are generated based on the acoustic/audio cues. Such visual cues highlight and/or de-emphasize parts of the text displayed to the learner according to the acoustic/audio cues. Likewise, before a differentiated oral prompt (or an oral prompt) is modified or manipulated to include such visual cues, it can be called an oral prompt or differentiated oral prompt as well for the sake of simplicity.

The ability of the learner apparatus to generate concise and relevant differentiated correction prompts for the learner for a learning task would help the learner to realize his or her mistake before the learner (particularly those with short attention span) loses concentration. Feedback provided to learners in conventional AI tutors are generally not concise and may cause delay in finding out cause of mistake. Extra work may be required by the learner to digest unconcise feedback, thereby resulting in loss of concentration, interest and/or motivation, which will hamper learning efforts.

By providing direct and/or concise feedback using differentiated correction prompts, the learner apparatus of the present example can reduce learner's frustration and precious time, thereby enabling learners (or students) to progress faster.

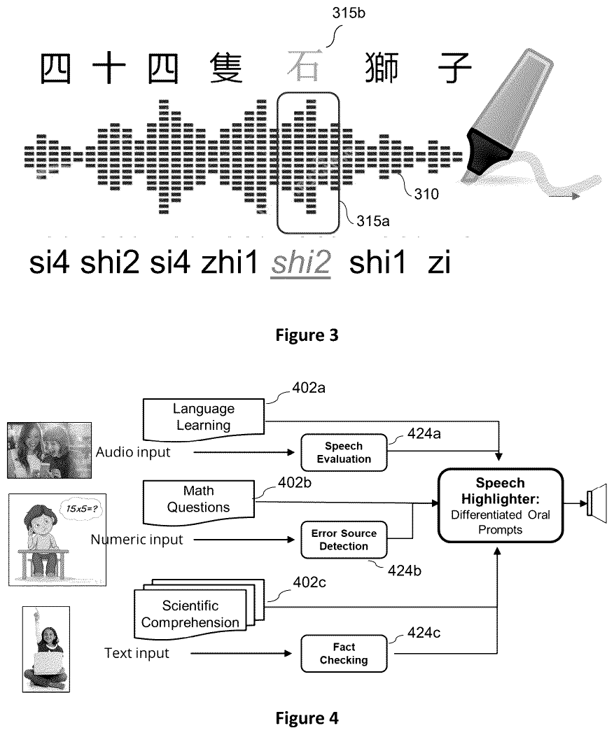

In addition, differentiated instructions (or differentiated responses) that can be provided by the learner apparatus is configured to resonate with students. This can be achieved by including a speech highlighter, which will be described later with reference to FIGS. 2 and 3. The speech highlighter is designed to convey meaning to a learner via denotation and/or connotation, thereby increasing the learner's learning engagement levels.

An example of a method for generating differentiated instructions according to students' varied learning capability that can be performed by the learner apparatus is discussed in the following paragraphs.

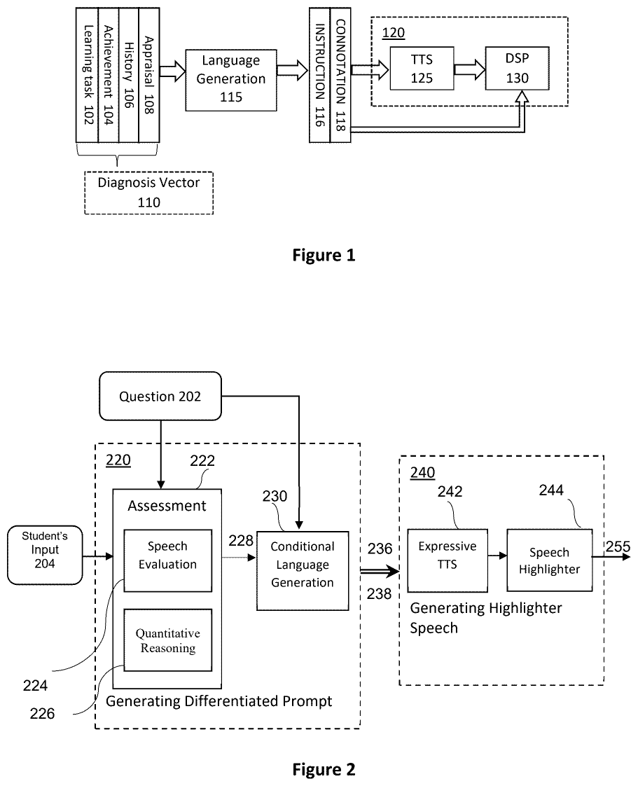

With reference to FIG. 1, to generate differentiated instructions according to a student's learning task, a conditional language generation model is used. The inputs of said model are data of a learning task 102 and an assessment result 104 of this learning task 102. The output of said model is differentiated oral prompts regarding the student's performance for the learning task 102. The differentiated oral prompts may include help or guidance information to facilitate learning and/or provide compliments/encouragement.

At the input side, a diagnosis vector 110, which is derived or obtained from an AI assessment module, may be utilised to represent each student's achievement 104 for the learning task 102. Such AI assessment module may operate based on a neural network or a predefined algorithm. The diagnosis vector may be a vector comprising one or more parameters pertaining to a student's performance for the learning task 102. One of the parameters may be a score given for completing the learning task 102. Other than considering achievement (i.e. the score) 104 obtained for completing the learning task 102, the diagnosis vector may also take into account each student's academic history 106 and teacher's appraisal 108. The diagnosis vector may also contain the student's answer as one of the parameters in some instances. In one example, one of the parameters may be a student's academic ranking in a class or school for the learning task, a review given by a peer or an educator for the student for the learning task, a comparison value indicative of a student's performance compared to earlier tasks completed, compared to another student, or compared to average performance of a group of students, etc. Mathematically, the diagnosis vector may be represented in a form of <a, b, c>, wherein for example, a is the score obtained for completing the learning task, b is student's ranking in a group of students completing the same learning task, and c may be a pointer to a string of text related to an appraisal by a teacher. The diagnosis vector 110 can accurately reflect a learning problem a student is facing for the learning task 102 at the present stage.

As shown in FIG. 1, the diagnosis vector 110 obtained from the AI assessment module is inputted to a conditional language generation model 115. The diagnosis vector 110 may contain information about how well the student did, the student's answer, and/or information to determine what correction prompt to generate and be communicated to the student who has completed the learning task 102. The student's answer may be incorporated with the diagnosis vector 110 or separately inputted to the AI assessment module.

For the example of FIG. 1, the diagnosis vector 110 has all the information required by the language model 115 to generate conditioned feedback on the student's learning. It includes learning task 102, achievement 104, academic history 106 and teacher's appraisal 108, which can be in the form of the following vectors.
1. Learning task vector 102, which can be a one-hot or distributed vector pre-assigned for each learning task. It can be one of the inputs of an assessment module (i.e. part of the specific task 202 in FIG. 2 to be described later).
2. Achievement vector 104, which can be an output of the assessment module. For different learning tasks, this vector can represent the result of qualitative or quantitative assessment on the learner's input.
3. History vector 106, which can be aggregated achievement of the student in the past.
4. Appraisal vector 108, which is the teacher's input. Such appraisal vector is optional. In case that there is no input from any human tutor, this vector can be set as an average value of a teacher's input on all training or learning data (i.e. data about the learning of the student).

The output of typical language generation models is only text. However, text itself is vague in conveying paralanguage cues, such as tone, pitch, stress (or prosody), volume, and speed, which are important for learning. To avoid losing these important cues, the present method may comprise a step of deriving a connotation vector 118. Such connotation vector may contain parameters pertaining to tone, pitch, stress (or prosody), volume, and speed. For instance, the connotation vector may contain values indicative of level of speech tone, pitch, stress, volume and speed. The connotation vector 118 is calculated alongside a text instruction 116. The text instruction 116 indicates the words to be spoken orally, e.g. via a speaker device. The text instruction 116 may be generated based on the information provided in the diagnosis vector and/or a learner's answer or response to the learning task 102. For example, the text instruction may be a predetermined feedback given based on the learner's answer or response to the learning task 102. The connotation vector 118 indicates how the words are to be spoken by highlighting the paralanguage cues during the generation of the oral prompt to a learner. The connotation vector 118 may be generated based on the information provided in the diagnosis vector, the learner's answer or response to the learning task 102, and/or based on the text instruction 116.

For example, in the case that the learner have failed to complete the learning task or has not performed sufficiently well, the differentiated correction prompt, in the form of an oral prompt, to be presented by the learner apparatus may indicate score obtained, provide correct answer, provide explanation of the answer, explanation of what caused the failure, inform the learner how he or she compared to other peers, and/or provide a teacher's or peer's feedback. The correct answer provided in the case of failure may include a speech highlight that may be acoustic and/or visual. In the case that the learner completed the learning task well, the differentiated response, in the form of an oral prompt, may be an indication of score, provide correct answer, a compliment, how he or she is ranked compared to other peers, and/or an indication of what was done well.

Furthermore, the present method for generating differentiated oral prompts comprises a step of processing the connotation vector 118 along with the text instruction 116. Specifically, the text instruction 116 and connotation vector 118 are sent to a Text-to-Speech (TTS) Synthesizer 120, which comprises a Text Analysis module 125 and a Digital Signal Processing (DSP) Module 130. The text analysis module 125 produces a phonetic transcript of the text to be read that is provided by the text instruction 116, and divides and marks the text into prosodic units, like phrases and sentences. If the text to be read contains numbers and abbreviations, it should be converted into the equivalent of written-out words. The produced phonetic transcript or transcription is then sent with prosodic information (e.g. desired intonation and rhythm) to the DSP module 130. The prosodic information is provided by or derived from the connotation vector 118. Thereafter, the DSP module 130 produces synthetic speech corresponding to the text to be read.

Unlike a conventional TTS synthesizer that generates speech of a uniform style which can only portray a surface meaning of the text read, the TTS synthesizer 120 is configured to modify prosodic information before the text is read out to a learner. The modifications to be made to the prosodic information is provided in the form of the connotation vector. The connotation vector may be generated taking into consideration the diagnosis vector associated with each learning task and/or the learner's response or answer to the learning task. The diagnosis vector is indicative of the learner's performance and may include the learner's response or answer to the learning task for consideration. The generated differentiated oral prompt emphasizes certain parts of the speech according to the prosodic information so that the learner learns better compared to the conventional uniform style of speech. In particular, the TTS synthesizer 120 is configured to manipulate fine-grained regions of a speech signal with acoustic alternations in intonation, temporal rhythm, and loudness to attract attention subtly.

For example, if the diagnosis vector indicates that a learner failed to complete a learning task, the connotation vector can be configured to make the oral prompt to be generated sound more empathetic, more encouraging, more instructive etc. The oral prompt may also stress parts of the oral prompt to pinpoint mistakes of the learner. If the diagnosis vector indicates that the learner has successfully completed the learning task, the connotation vector can be configured to make the oral prompt to be generated sound like praises.

Expressive (highlighted) oral prompt can be used to emphasize the hints to completing a learning task successfully. It can give learners a new level of understanding. For instance, a certain part of the oral prompt is made louder and slower to provide an acoustic cue to a learner, so that the learner can identify “hidden” meaning between the text easily. The ability to generate customized speech to different learners can also instill care and genuineness in AI education, and thus, inspire the learners to endeavor more in their learning journey.

In another example, the text instruction 116 can be the feedback generated with denotative words/sentences. Such denotative words/sentences contain the contents of what the monotone voice of today's AI tutors are speaking.

However, unlike today's AI tutors, the connotation vector 118 of the present example can be created to enable the AI tutor to actively take ownership of the learning process through expressive instructions, attract the attention of the learner, and inspire the learner in a differentiated way. The connotation vector 118 may be associated with a set of affective settings defined for education purpose. Such affective settings are:
Instructive and/or Encouraging;
Delightful and/or Joyful;
Reproachful; and
Peremptory.

For instance, the connotation vector 118 may contain 4 values, each pertaining to a degree or level of each of the 4 settings above.

Beside affective settings, the connotation vector 118 can also indicate errors made by the learner, remind revisions to the learner by emphasizing words and phrases in the text instruction 116 (i.e. hint to the learner how his or her answer should be answered, corrected and/or improved).

A highlighting mask (or stress mask) (e.g. 238 in FIG. 2) may be adopted to implement rhythm structure in the voice i.e. differentiated oral prompt to be generated for the learner to convey connotative meanings of the text instruction 116. Such highlighting mask can be part of or include the connotation vector 118, or provided separately from the connotation vector 118. Some examples are provided as follow:
If a student is struggling in learning, a language model can be implemented to generate text instruction 116 with affective setting of “instructive and/or encouraging”. In this example, the Text-to-speech synthesizer 120 and Digital Signal Processor (DSP) 130 will apply the stress mask according to an iambic meter (Unstressed and stressed rhythm) Such iambic meter tends to have a gentle and flowing quality that imparts a sense of encouragement. The voice of the oral prompt will be created with a natural and comforting rhythm, like a steady heartbeat. The student will be reassured with a sense of stability and steadfastness. Specifically, iambic meter is a style of poetic verse in which every other beat—or syllable—is stressed. E.g. an unstressed (or unaccented) syllable followed by a stressed (or accented) syllable.
If a learner is distracted and his/her attention is drifting away from the learning, the affective setting of “peremptory” can adopt the stress mask according to a spondaic meter (Stressed and stressed rhythm). The constant stressing of syllables invokes a feeling of urgency. It alerts the learner to immediately draw attention to the learning. Specifically, spondaic meter is a style of poetic verse in which every beat—or syllable—is stressed. E.g. a stressed (or accented) syllable followed by another stressed (or accented) syllable.
When a student is making progress, the affective setting of “delightful and/or joyful” can adopt the stress mask according to a trochaic meter (stressed and unstressed rhythm) to create a lively and upbeat rhythm. Traditionally, writers associate trochaic rhythm with the feeling of happiness. Specifically, trochaic meter is a style of poetic verse that has a “falling rhythm”. E.g. a stressed (or accented) syllable is on the first beat followed by an unstressed (or unaccented) syllable.
When a learner makes a mistake, the affective of “reproachful” can adopt the stress mask in a dactylic meter (stressed, unstressed, and unstressed rhythm). This creates a sense of forceful momentum, mirroring the rising anger and passion of the tutor, and evokes a feeling of urgency and agitation. Specifically, dactylic meter is a style of poetic verse that has a stressed (or accented) syllable followed by two unstressed (or unaccented) syllables.
In addition to the above, the highlighting mask can be set to emphasize (put stress on) certain words in a sentence to tell a learner what is important and brings clarity to the connotation meaning with the text instruction 116. E.g. The following sentences (which ae sample text instructions 116) have exactly the same denotation meaning. However, by stressing different words, the generated differentiated oral prompt in voice or in text for the sentences draws the learner's attention to different parts of the sentences.
   SALLY sells seashells by the seashore.
   Sally SELLS seashells by the seasho
   Sally sells SEASHELLS by the seashore.
   Sally sells seashells by the SEASHORE.

The affective setting and stress mask pattern described above can be summarized in Table 1 below.

TABLE 1
Mapping between affective settings in connotation
and corresponding stress mask patterns

| Affective Setting | Stress Mask Pattern |
|---|---|
| Instructive and/or Encouraging | Lambic Meter |
| Peremptory | Spondaic Meter |
| Delightful and/or Joyful | Trochaic Meter |
| Reproachful | Dactylic Meter |

A method for generating expressive speech, by emphasizing (highlighting) certain words/phrases in a sentence that can be performed by the learner apparatus described above is discussed in the following paragraphs.

Speech is irreplaceable in classroom education, which can effectively convey easy-to-receive and connotation beyond text to the targeted audience. In such traditional education settings, heuristics, suggestive corrections, etc. are used widely as scaffolding when helping students (or learners) to discover errors on his/her own.

The method for generating expressive speech that can be performed by the learner apparatus leverages on the intuitive and suggestive nature of speech characteristics to provide stronger acoustic cues in a selected region of the speech signal, thus providing guidance and allowing a learner to independently identify mistakes and formulate corrections.

In the example of the method for generating expressive speech described below, a student provides an oral or spoken answer to a specific task 202, which can be in the form of a question. The oral or spoken answer is the student's individual response 204.

With reference to FIG. 2, the method comprises two stages 220 and 240. The first stage 220 relates to the generation of text or text string 236 of a distinct oral prompt, highlighting masks 238 based on the specific task 202 and the student's individual response 204. The second stage 240 relates to the generation of highlighted speech 255 for the distinct oral prompt. The term “highlighted speech” described herein refers to speech produced by a DSP module (e.g. 130 of FIG. 1), wherein at least one part of the speech has acoustic alterations in intonation, temporal rhythm, and loudness. The acoustic alterations are configured to attract attention subtly.

In the first stage 220, there is provided an automatic assessment step 222 performed by the learner apparatus for the student's individual response 204. The assessment result is used to derive a personalized helping prompt (i.e. a differentiated correction prompt). During the assessment step 222, an evaluation is conducted on the student's individual response 204 to the specific task 202. For example, the learner apparatus is configured to detect one or more pronunciation problems in the student's voice during speech evaluation 224 if the specific task 202 is a language learning task. If the specific task 202 is a multi-step mathematics problem, the learner apparatus is configured to decompose the mathematics problem into its solution steps, and pinpoint the possible misconceptions, misunderstandings, and gaps in knowledge in the student's individual response 204 during a quantitative reasoning step 226.

An AI assessment module used for assessing the student's response may operate using a Speech evaluation model, a quantitative reasoning model and/or a language generation model. The AI assessment module may be a neural network and the models may be trained on annotated datasets for specific learning tasks. In one example, Google's Minerva language model (>100B parameters) demonstrates the capability of processing scientific and mathematical questions (or tasks) formed in natural language and generating a step-by-step solution. The Minerva model also incorporates prompting and evaluation techniques.

For example, the learning task may be a mathematics task in the form of a multiple choice question (MCQ). In this example, the AI assessment module is configured to conduct a binary assessment (i.e. True or False) 228 for each answer choice of the MCQ. The AI assessment module may use a conditional language generation model 230 that focuses on generating meaningful prompts based the binary assessment results 228. The assessment may not be focused on identifying the correct answer but rather to provide a meaningful prompt for each answer choice be it the right answer or the wrong answer. It has been observed that in the case that the learning tasks are multiple choice questions, having large amounts of training data for training the AI assessment module can maximize its performance of generating meaningful differentiated instruction s for each MCQ answer. The meaningful prompts may include the correct answer of an MCQ and/or a compliment if the correct answer is given, and if the wrong answer is given for the MCQ, a correction prompt guiding learners to the correct answer. For example, if a learner selects a wrong answer for an MCQ, an oral prompt guiding the learner to get the correct answer is given, rather than an oral prompt giving the correct answer directly.

The learner apparatus is configured to output, based on the assessment results 228, parameters for generating a differentiated oral prompt from the conditional language generation model 230 (be it the learner obtained a right answer or a wrong answer to the question), wherein the parameters include the highlighting masks 238 (which can be part of or include the connotation vector 118 of FIG. 1, or provided separately from the connotation vector 118), and the text instruction or text string 236 to be read. Such parameters are used in the second stage 240 to provide an acoustic (or audio) cue and/or visual cue. The text instruction or text string 236 is to be modified by an expressive TTS Synthesizer 242. At least one part of the synthetic speech of the text string (i.e. the acoustic or audio cue) output by the TTS Synthesizer 242 has acoustic alterations in intonation, temporal rhythm, and loudness. The acoustic alterations may be altered according to prosodic information provided by the highlighting masks 238. Key parts of the audio cue are highlighted (e.g. set to higher volume) or de-emphasized (e.g. set to lower volume). A speech highlighter 244 is provided to output such highlighted speech as an audio file or to play it on an audio speaker.

The speech highlighter may be configured to display a visual cue for the differentiated oral prompt. The visual cue can be displayed as the differentiated oral prompt is read out. The visual cue may be displayed in text format and visually highlight key parts of the displayed text according to the corresponding audio cue. For example, the highlights applied to the key parts of the displayed text may be in the form of, for example, capitalized alphabets, colour, bold, underline, italic, coloured/shaded highlight etc. In one example, it could be that only visual cues highlighting key parts are displayed and the oral prompt to be outputted via a speaker is not provided.

In addition, the speech highlighter 244 can be configured to highlight (or emphasize) or de-emphasize, acoustically and/or visually, the key parts of the audio and/or visual cue at syllable, word, phrase level, and/or at different parts of the differentiated instruction.

A specific example of the application of the two stages 220 and 240 for generating differentiated correction prompts and generating highlighted speech is described as follows with reference to FIGS. 2 and 3.

In this example, a student is presented with a language learning task (or question) to read a Chinese sentence on a learner apparatus installed with software providing the learning task. The language learning task is a question displayed on a screen of his or her learner apparatus. Through a graphical user interface, the student submits a response (or answer) using a microphone of the learner apparatus. The response to the learning task is received and assessed by the learner apparatus. An AI assessment module, which is a component of the software, is activated to assess the response. In this example, the student's response to the learning task is a wrong reading of the Chinese phrase “ [symbol] (Forty four stone lions)”. After assessment, the AI assessment module instructs the learner apparatus to read out the correct answer comprising a differentiated oral prompt through a speaker of the learner apparatus. Specifically, the correct answer highlights a part 315b of the student's response that was assessed to be wrong. In this case, the Chinese character “ [symbol] (stone)” was read wrongly by the student.

The AI assessment module may be a neural network subject to machine training for recognizing wrong reading or a non-neural-network algorithm configured to recognize wrong reading.

In this example, the text string 236 to be read by the learner apparatus is the phrase “ [symbol] [symbol] (Forty four stone lions)”. An audio stream or file containing synthetic speech 310 of the text string 236 is generated. Upon recognizing the pronunciation error, the AI assessment module generates highlighting masks 238 (which may be part of or include the connotation vector, or provided separately from the connotation vector) for sending to the TTS synthesizer 242. The TTS synthesizer 242 modifies the prosody of the wrongly read character “ [symbol] (stone)” in the synthetic speech 310 to be louder and slower according to the highlighting masks 238. The modified synthetic speech 310 constitutes the differentiated oral prompt. When the learner apparatus reads out the correct answer containing this differentiated oral prompt through the speaker, the part of the correct answer with the modified prosody acts as an acoustic cue to the student to aid the student to understand that he or she read “ [symbol] (stone)” wrongly.

In this example, a visual display of the differentiated oral prompt is also provided by the speech highlighter 244. The speech highlighter 244 is configured to box up the error (see box 315a in FIG. 3) and show the wrongly read word in a different font colour as the correct answer is being read out through a speaker of the learner apparatus. In this manner, a differentiated correction prompt with multimodal stimulation (including highlighted speech and visual guide) is presented to the learner to emphasize (or pin-point) an error to be corrected. After the differentiated correction prompt is presented, the learner may be asked to re-try the learning task. This helps the student to learn the correct pronunciation of the word.

An example of the conditional language generation model (i.e. a prompt generation model) can be summarized by the following conditional entropy for generating a differentiated multimodal instruction.

$$Conditional Entropy for prompt inference$$

$$E ( {y}_{t} ) = - {\sum }_{t = 0}^{M} log ( p ( {y}_{t} \vert X , {y}_{0} , … , {y}_{t - 1} ) )$$

$$X = ( {x}_{0} , … , {x}_{N} ) is the learning task and diagnosis ;$$

$$Y = ( {y}_{0} , … , {y}_{M} ) i s the generated prompts with highlights$$

In particular, the learning task, learner's response (e.g. answer given by learner), and task-specific diagnosis (assessed by the AI assessment module) are inputs to the conditional language generation model for determining personalized differentiated helping prompt for the learner. The output of the conditional language generation model is a multi-modal corrective prompt, wherein the multi-modal corrective prompt comprises synthesized speech (i.e. generated prompt with highlights) read out to the learner, and at least one part of the synthesized speech has acoustic alterations in intonation, temporal rhythm, stress and/or loudness.

Instead of an objective evaluation, the learner apparatus described in examples of the present disclosure is configured to subjectively evaluate the overall performance through more than one application tasks. In one example, there is provided a first application task, which is to help students solve mathematics (words) problems, and a second application task, which is to correct student's pronunciation in language education. There may be provided another application task which is to help students with scientific comprehension.

FIG. 4 illustrates a step of generating a differentiated oral prompt acoustically and/or visually, which can be used in many use cases. For instance, there may be a plurality of students attempting learning tasks. A differentiated prompt is generated for each student based on the student's achievement (i.e. based on the diagnosis vector) for their current learning tasks (or application tasks) 402a, 402b and 402c.

The student's response can be an audio input for a language learning task 402a, a numeric input for a math learning practice 402b or a text input for a scientific comprehension task 402c. Note that although in this example, audio input is for language task, numeric input is for math task and text input is for science task, such audio, numeric and/or text input is applicable to all of the language, math and science tasks. For instance, a numeric input can be an answer to a multiple-choice question on any subject, and text inputs and/or audio inputs can be provided as answers for any subject.

The assessment process for the student's response i.e. 402a, 402b and 402c is task-specific and can involve speech evaluation 424a and/or quantitative reasoning, such as error source detection techniques 424b and fact checking 424c. A neural network may be used in the assessment process or it may be a less complex algorithm for comparing the student's response against correct answers stored in a database.

After assessment, a concise and relevant differentiated oral prompt is generated by the speech highlighter 244 in FIG. 2 based on the assessment results for each learning task. In one example, the learner apparatus is configured to present a multi-modal differentiated correction prompt when the response from the learner is deemed as an incorrect response to the learning task. For instance, a selected fine-grained region of a synthesized speech signal is manipulated to include acoustic alterations in intonation, temporal rhythm and loudness to give stronger acoustic cues to guide a student to make a correction on his or her own. A visual cue can also be displayed synchronously (or not synchronously) with the manipulated acoustic cues to provide assisted learning scaffolding.

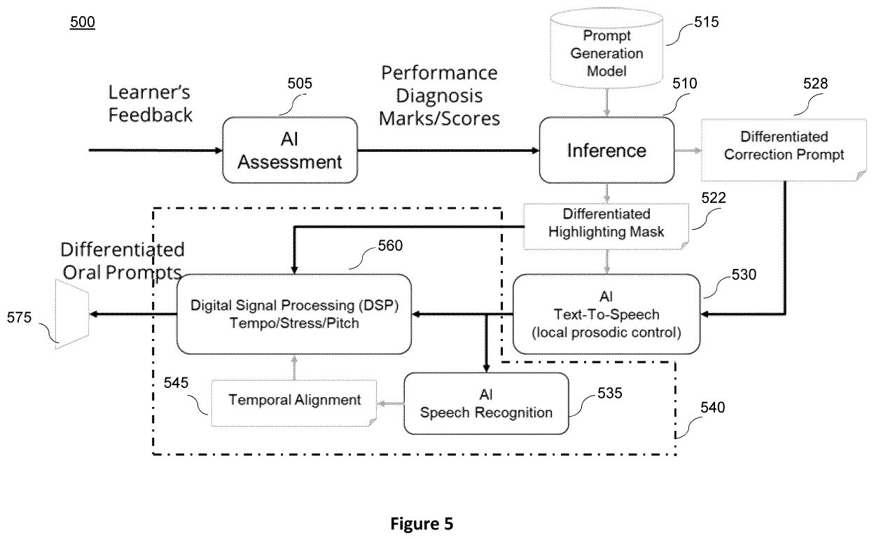

FIG. 5 illustrates another example of a method 500 for generating one or more differentiated oral prompt to a learner (or a student). Such method 500 is executed on a learner apparatus or device made available to the learner (such as a mobile or desktop computing device). The method 500 comprises presenting a learning task to a learner on a display and receiving a learner's feedback (or answer to the learning task). The display may be part of the learner device or a display unit (e.g. LCD screen) external to the learner device (such as a desktop). The learning tasks (or application tasks) may be a language learning question, math question, science question or a question that can be used to meet the learning needs of the learner. It should be appreciated the learning tasks can also cover other fields of studies, such as science, accounting, computing etc. The learner's answer to the learning task can be in the format of audio input, numeric input, and/or text input.

The method 500 comprises assessing the learner's answer at a step 505 to determine a diagnosis input (e.g. diagnosis vector), and subsequently performing a diagnosis or an assessment at a step 510, based on the diagnosis input using a prompt generation model 515 to generate a differentiated correction prompt 528 (e.g. in the form of a text string, audio, image and/or video) and a differentiated speech highlighting mask 522. In the present example in which the learner's answer is not correct, the differentiated correction prompt 528 includes a text string to be processed.

The diagnosis or assessment process of the present method 500 is task-specific and can involve speech evaluation and/or quantitative reasoning, such as error source detection and/or fact checking. The prompt generation model 515 may comprise a library of prompts, wherein each prompt is task-specific and/or feedback-specific. The differentiated correction prompt 528 may not be a direct answer or an explicit solution to the learning task. The correction prompt 528 may be hints to guide the learner to arrive at the correct answer. Providing such correction prompts 528 will guide a learner to acquire the necessary skill and knowledge to manage similar learning tasks. Providing the correct answer directly may not achieve this objective.

In one example, the diagnosis input is a diagnosis vector, and may include an MCQ answer, a right/wrong indication, or a mark/score provided by the learner device (after assessment at step 510). The differentiated highlighting mask 522 is a highlighting mask vector (which can be part of or include the connotation vector, or provided separately from the connotation vector) used to highlight and/or de-emphasize parts of an audio output. The differentiated highlighting mask 522 may include data indicative of pitch, volume and/or tempo settings to be adjusted for a differentiated oral prompt 575 playable on a speaker. For instance, a character counter may be used to determine a syllabus, word, phrase of the differentiated correction prompt.

At step 530, the text string of the differentiated correction prompt 528 and the differentiated speech highlighting mask 522 are inputted to an AI Text-to-Speech module (TTS module), which performs local prosodic control to apply speech highlights/adjustments specified by the speech highlighting mask 522 on the text string. The highlights/adjustments may be made at a syllabus, word, character, and/or phrase level. The output of the TTS module may be a speech signal containing the highlights/adjustments specified by the speech highlighting mask 522. Such modified or adjusted speech signal may be an analog signal. The output of the TTS module is sent to a digital signal processor to convert the modified or adjusted speech signal into a digital format at a step 560. The output of the TTS module is also sent to an AI speech recognition model for speech recognition at a step 535, which recognizes the syllable, words, character, and/or phrases to be spoken.

Temporal information is extracted for these recognized syllable, words, character, and/or phrases for temporal alignment at a step 545. The AI speech recognition model 535 may be a model trained by machine learning. Information relating to temporal alignment from the temporal alignment step 545, the output from the TTS module, and the differentiated highlighting mask (speech highlights) 522 are inputted to a digital signal processor (DSP) for processing at a step 560. The DSP processes these inputs to generate digitized playable speech signals for the output from the TTS module that are temporally aligned according to the pitch, tempo and/or volume information specified in the speech highlights 522. The output of the DSP is the differentiated oral prompt 575 (in a digital audio file or audio stream format) that can be played by a media player and made audible via a speaker. The DSP module may also make enhancements to make the differentiated oral prompt 575 sound better.

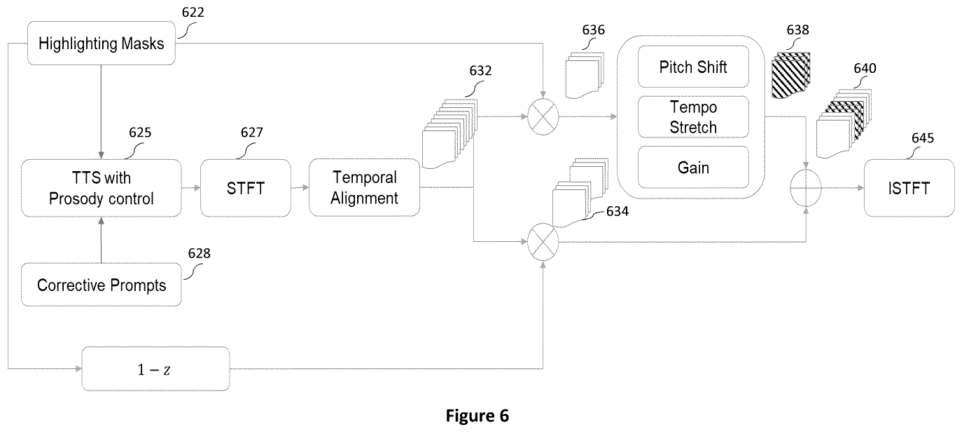

The AI speech recognition step 535, temporal alignment step 545 and DSP processing step 560 of FIG. 5 can be summarised as a digitization step 540. FIG. 6 illustrates an example of the digitization step 540 of FIG. 5. With reference to FIG. 6, Corrective (or Correction) Prompts 628 and Highlighting masks 622 are generated based on learner-specific and task-specific diagnosis results and they are provided to a Text-to-Speech module 625 (corresponds to the TTS module described for FIG. 5). The Text-to-Speech module 625 converts a text string of the Corrective Prompt 628 into a speech signal and adjusts the speech signal to contain the highlights specified by the Highlighting masks 622. The adjusted speech signal that is outputted from the Text-to-Speech module 625 is processed by an automatic speech recognition (ASR) module (corresponds to the AI speech recognition model described for FIG. 5), which makes use of the short-time Fourier Transform (STFT) algorithm 627 to segment the speech signal into a first series of frames 632. Each frame corresponds to the spectral characteristic of an individual piece of utterance (i.e. syllable, word, character, or phrase). These frames will facilitate temporal alignment of the digitized highlighted speech to be generated. During temporal alignment, at least one part 634 of the first series of frames 632 would be retained (not modified), and at least one other part 636 of the first series of frames 632 would be modified based on the highlighting mask 622. The prosodic parameters (such as pitch shift, tempo stretch, gain and the like) of at least one modified frame 638 are adjusted and outputted for combination with the retained frames 634 to form a second series of frames 640. Thereafter, the second series of frame 640 is processed by an inverse short-time Fourier Transform (ISTFT) algorithm 645 to produce a fine-tuned synthetic voice (DSP-generated audio output) for the learner.

A Digital Signal Processor (DSP) may be used to perform the short-time Fourier Transform (STFT) algorithm 627 and the inverse short-time Fourier Transform (ISTFT) algorithm 645. The DSP may be used to convert the adjusted speech signal that is outputted from the Text-to-Speech module 625 and the first series of frames 632 into digital format for processing. The DSP may also be used to process and output the at least one part 634 of the first series of frames 632, the at least one other part 636 of the first series of frames 632, the at least one modified frame 638 and the second series of frames 640 in digital format.

FIGS. 5 and 6 illustrate possible solutions for differentiated oral prompts in learning and are not to be taken as limiting. As technology evolves, there might be new (better) solutions for such task applying similar concepts as those covered in the present disclosure.

The following paragraphs provides additional examples of differentiated oral prompt generation, which involves subjective evaluation of learning tasks that require quantitative reasoning.

In the first example, a learner is presented with a mathematics question as shown below:

Example 1: Jack had two apples, he ate one, he plans to buy another tomorrow morning. How many apples will Jack have tomorrow?

Thereafter, a multi-modal correction prompt is presented in response to the learner's feedback. In this example, the mathematics question is a multiple-choices question (MCQ), and the learner selects an answer from a plurality of answer options. As shown below, when the learner selects an answer, a corresponding oral prompt will be generated. A diagnosis vector for this example can just be the selected answer in numeral. Taking in the diagnosis vector as input, an assessment module may retrieve a text instruction indicating the text of the oral prompt that is associated with the selected answer and a speech highlighting mask associated with the text instruction from a database.
A) 1 Prompt: He ate one and plans to buy another tomorrow.
B) 2 Prompt: Well done!
C) 3 Prompt: He has eaten one today and plans to buy another tomorrow.

For this learning task, if the learner chooses option A (i.e. answer being 1), the differentiated correction prompt generated would be “He ate one and plans to buy another tomorrow” and a speech highlighting mask generated would be “plans to buy another”. The oral prompt, when read out, will emphasize the words “plans to buy another” by making it louder and slower as compared with the rest of the sentence. In addition, the text of the oral prompt to be displayed will be adjusted to emphasize “plans to buy another” by displaying it in a different mode (e.g. bold, colour, highlight, underline, italics etc.) as compared with the rest of the sentence. In another example, the words “plans to buy another” maybe read progressively slower and with more variation in intonations, so that the learner can infer from the visual and/or audio cues to perform addition after subtraction (i.e. “2−1”), which is required to get the correct answer.

Likewise, if the learner chooses option C (i.e. answer being 3), the differentiated correction prompt generated would be “He has eaten one today and plans to buy another tomorrow” and the speech highlighting mask generated would be “He has eaten one today”. The oral prompt, when read out, will emphasize the words “He has eaten one today” by making it louder and slower as compared with the rest of the sentence. In addition, the text of the oral prompt to be displayed will be adjusted to emphasize “He has eaten one today” by displaying it in a different mode (e.g. bold, colour, highlight, underline, italics etc.) as compared with the rest of the sentence. In another example, the words “He has eaten one today” maybe read progressively slower and with more variation in intonations, so that the learner can infer from the visual and/or audio cues to perform subtraction before addition (i.e. “2+1”), which is required to get the correct answer.

If the learner chooses the correct answer (in this case, option B), the oral prompt and the speech highlighting mask generated would be “Well done”. This oral prompt, when read out, could be at a higher pitch to provide motivation to the learner. It is optional to modify the prosody of the oral prompt for the correct answer.

In a second example, a learner is presented with another mathematics question as shown below.

Example 2: My number has four digits and has a 7 in the hundreds place. The digit which has the highest value in my number is 2. The digit which has the lowest value in my number is 6. My number has 3 fewer tens than hundreds. What is my number?

A multi-modal correction prompt is presented after receiving the learner's feedback (or answer) to the question (learning task). In this example, the mathematics question is a multiple-choices question (MCQ), and the learner selects an answer from a plurality of answer options. In another example, the learner may be asked to provide the answer as a numeric input (i.e. by keying four digits into a learner device) in response to the learning task. As shown below, when the learner selects an answer, the corresponding oral prompt will be generated.
A) 2746 Prompt: Well done!
B) 3746 Prompt: The digit which has the highest value is 2.
C) 2736 Prompt: My number has 3 fewer tens than hundreds.
D) 2636 Prompt: The number has a 7 in the hundreds place.
E) 746 Prompt: The number has four digits.

For this learning task, if the learner chooses option B (i.e. answer being 3746), the differentiated correction prompt generated would be “The digit which has the highest value is 2” and the speech highlighting mask generated would be “the highest value is 2”. The oral prompt, when read out, will emphasize the words “the highest value is 2” by making it louder and slower as compared with the rest of the sentence. In addition, the text of the oral prompt to be displayed will be adjusted to emphasize “the highest value is 2” by displaying it in a different mode (e.g. bold, colour, highlight, underline, italics etc.) as compared with the rest of the sentence. In another example, the words “the highest value is 2” maybe read progressively slower and with more variation in intonations, so that the learner can infer from the visual and/or audio cues to understand that the digit at the thousands place of a four-digit value is 2.

In the event the learner chooses option C (i.e. answer being 2736), the differentiated correction prompt generated would be “My number has 3 fewer tens than hundreds” and the speech highlighting mask generated would be “3 fewer tens than hundreds”. The oral prompt, when read out, will emphasize the words “3 fewer tens than hundreds” by making it louder and slower as compared with the rest of the sentence. In addition, the text of the oral prompt to be displayed will be adjusted to emphasize “3 fewer tens than hundreds” by displaying it in a different mode (e.g. bold, colour, highlight, underline, italics etc.) as compared with the rest of the sentence. In another example, the words “3 fewer tens than hundreds” maybe read progressively slower and with more variation in intonations, so that the learner can infer from the visual and/or audio cues to understand that the difference between the digit at the hundreds place and the digit at the tens place is 3 and that the digit at the hundreds place is 7.

Likewise, if the learner chooses option D (i.e. answer being 2636), the differentiated correction prompt generated would be “The number has a 7 in the hundreds place” and the speech highlighting mask generated would be “has a 7 in the hundreds place”. The oral prompt, when read out, will emphasize the words “has a 7 in the hundreds place” by making it louder and slower as compared with the rest of the sentence. In addition, the text of the oral prompt to be displayed will be adjusted to emphasize “has a 7 in the hundreds place” by displaying it in a different mode (e.g. bold, colour, highlight, underline, italics etc.) as compared with the rest of the sentence. In another example, the words “has a 7 in the hundreds place” maybe read progressively slower and adjusted to apply prosodic stress for “hundreds place”, so that the learner can infer from the visual and/or audio cues to understand that the digit at the hundreds place is 7.

If the learner chooses option E (i.e. answer being 746), the differentiated correction prompt generated would be “The number has four digits” and the speech highlighting mask generated would be “has four digits”. The oral prompt, when read out, will emphasize the words “has four digits” by making it louder and slower as compared with the rest of the sentence. In addition, the text of the oral prompt to be displayed will be adjusted to emphasize “has four digits” by displaying it in a different mode (e.g. bold, colour, highlight, underline, italics etc.) as compared with the rest of the sentence. In another example, the words “has four digits” maybe read progressively slower and adjusted to apply prosodic stress for “four”, so that the learner can infer from the visual and/or audio cues to understand that the answer should be made up of four 4 numbers (i.e. digits).

If the learner chooses the correct answer (in this case, option A), the oral prompt and the speech highlighting mask generated would be “Well done”. This oral prompt, when read out, could be at a higher pitch to provide motivation to the learner. In another example, there could be clapping sounds after the word “Well done” is read out. Instead of displaying the words “Well done!” to the learner, an image or a video (e.g. GIF) may also be displayed to motivate the learner. It is optional to modify the prosody of the oral prompt for the correct answer.

In another language learning example, the learner device is configured to present a language pronunciation guide and/or highlight difficult sounds, words and phrases to a specific learner. For instance, when a learner is tasked to read a passage and the passage include words which the learner had made mistakes (from previous tasks), the learner device may be configured to display a list of the problematic words and the associated speech samples for a learner to consult with before the learner begins an attempt on the learning task. In yet another example, the difficult words (determined from a learner's historical records) may be displayed in a mode different (e.g. bold, highlight, underline, colour etc.) from the rest of the passage so that the learner can be more aware of his or her pitfalls.

In summary, generally, the examples of the method of AI-assisted learning disclosed in the present disclosure monitors a feedback (or response) to a learner's specific learning task and provides relevant help regarding the learner's difficulties for said specific learning task. Informative oral instructions are provided to convey accurate information effectively to the learners clearly and keep the listener focused on the task at hand. A prompt language generation model is configured to generate personalized help information in accordance to variance in students' learning capability. Refined synthetic speech is produced to help the learner should a mistake be made or prior to an attempt by the learner on a learning task. The synthetic speech is created by modifying prosodic parameters (e.g. intonation, temporal rhythm and loudness) of at least one part of the speech to provide an acoustic cue to a learner, so that the learner can identify hidden or implied meaning between the text (of the learning task) easily to guide them to correct his or her mistake or guide them to give the correct answer. Informative vocal signals (or acoustic cues) can be achieved by using a speech recognition model (e.g. ASR acoustic model), which helps to achieve temporal alignment of the differentiated oral prompt (containing speech highlights) at the syllable, character, word or phrase level. This speech recognition model may be a model trained by machine learning. Information relating to temporal alignment, a modified speech signal containing speech highlights from a Text-To-Speech (TTS) module, and a differentiated highlighting mask (speech highlights) are inputted to a digital signal processor (DSP). The DSP processes these inputs to generate digitized playable speech signals for the speech signal from the TTS module that are temporally aligned according to the pitch, tempo and/or volume information specified in the speech highlights.

### Experimental Data:

Table 2 below shows comparison results of an example according to the present disclosure against a human tutor and a system operating using existing technology.

### Table 2:

Testing Corpus: Singapore Examination and Assessment Board (SEAB) Language Learning Task (226 sentences)

Dictation Vocabulary Size: 206,510

| | | Existing | Smart Tutor |
|---|---|---|---|
| | | technology | according to |
| | | based on | an example of |
| | Human | Text-To-Speech | the present |
| | Tutor | (LJSpeech) | disclosure |
| Phone Error Rate (PER) | 23 | 34.5 | 36.3 |
| Rel/Inc | −33% | — | <5% |

“Rel/Inc” stands for ‘Relative Increase’ of Phone Error Rate. Table 2 illustrates the limitations of conventional AI tutor (LJSpeech). With regard to the smart AI tutor according to an example of the present disclosure, the quality of oral feedback in the differentiated oral prompt comprises at least 2 aspects: expressiveness and intelligibility. Existing TTS modules (like LJSpeech) always speak in a monotone voice with no expressiveness and learners cannot perceive connotation meaning from it. Its intelligibility loss is significant compared to a Human tutor's voice. Intelligibility loss is evaluated by the Relative Increase of Phone Error Rate (Speech Recognition). On the other hand, the AI tutor of the examples of the present disclosure can deliver connotation meaning in oral prompt (like a Human tutor) with low trade off in intelligibility (relative <5% compared to existing TTS modules) on expressiveness.

Examples of the present disclosure may have the following features. The reference numerals in parentheses refer to the reference numerals of the elements in the Figures.

A method or apparatus for generating one or more differentiated oral prompt for learning, the method or apparatus involves performance of presenting a learning task (e.g. 102 in FIG. 1, 202 in FIG. 2) to a user (or learner) on a display; receiving user feedback (e.g. 104 in FIG. 1, 204 in FIG. 2; e.g. a user's answer) to the learning task; determining a diagnosis input (e.g. 228 in FIG. 2) based on the user feedback; performing a diagnosis, using a prompt generation model (e.g. 115 in FIG. 1, 230 in FIG. 2, 515 in FIG. 5), on the diagnosis input to generate a differentiated oral prompt (e.g. 575 in FIG. 5; e.g. a text string) and a differentiated speech highlighting mask (e.g. 238 in FIG. 2; e.g. the highlighting mask vector, which may include data indicative of pitch, rhythm, volume and/or tempo settings) associated with the differentiated oral prompt; input the differentiated oral prompt and the differentiated speech highlighting mask to a Text-to-Speech module (e.g. 125 in FIG. 1, 625 in FIG. 6) with prosody control to generate speech signals for reading out the differentiated oral prompt with speech highlights specified in the differentiated speech highlighting mask; and converting the speech signals into a format for reading out the differentiated oral prompt with the specified speech highlights through an audio device.

Regarding the method or apparatus for generating one or more differentiated oral prompt to a user, the method may further comprise performing prosody control at word level, character level, or phrase level of the differentiated oral prompt.

Regarding the method or apparatus for generating one or more differentiated oral prompt to a user, the method or apparatus may further comprise using a speech recognition model (e.g. 535 in FIG. 5; e.g. ASR acoustic model) to achieve temporal alignment of the differentiated oral prompt with the speech highlights at the word level, character level, or phrase level, wherein the speech recognition model may be a model trained by machine learning, wherein information relating to the temporal alignment and the speech highlights may be inputted to a digital signal processor (DSP) (e.g. 130 in FIG. 1) to generate the speech signals according to pitch, tempo and/or volume information specified in the speech highlights. The DSP may also take in the speech signals generated by the Text-to-Speech module as input.

The prompt generation model used to perform the diagnosis on the diagnosis input to generate the differentiated oral prompt may be a model trained by machine learning, and each differentiated oral prompt may be specific to the learning task presented to the learner.

The speech recognition model may be configured to use short-time Fourier Transform (STFT) to segment a speech signal from the Text to Speech module into a first series of frames (e.g. 632 of FIG. 6), wherein each frame corresponds to spectral characteristic of an individual piece of an utterance (e.g. a word, a phrase, a character, a syllable etc.).

The first series of frames may be associated with the information relating to temporal alignment, wherein during temporal alignment, prosodic parameters of at least one part of the first series of frames are modified based on speech highlights specified in the differentiated speech highlighting mask to form a second series of frames (e.g. 640 of FIG. 6).

The second series of frame may be processed by an inverse short-time Fourier Transform (ISTFT) to produce the speech signals to be converted into the format for reading out through the audio device (e.g. an audio speaker).

Regarding the method or apparatus for generating one or more differentiated oral prompt to a user, the method may comprise checking the diagnosis input to determine whether differentiated oral prompt is required for the learning task prior to commencement of a step of inputting the differentiated oral prompt and the differentiated speech highlighting mask to a Text-to-Speech module with prosody control to generate speech signals for reading out the differentiated oral prompt with speech highlights specified in the differentiated speech highlighting mask.

The method may comprise checking the diagnosis input to determine whether differentiated oral prompt is required for the learning task prior to commencement of step (e).

The method may comprise presenting a virtual cue on the display to the user to aid in the completion or correction of the learning task. The visual cue may be displayed in text format and a part of the displayed text maybe highlighted according to the differentiated speech highlighting mask, wherein the part of text may be displayed in the form of capitalized alphabets, bold, underline, italic, and/or a colour different from the rest of the text.

The diagnosis input may be determined based on evaluation of speech (e.g. for language learning) in the user feedback.

The diagnosis input may be determined based on a result obtained from error source detection (e.g. for math subject learning) in the user feedback.

The diagnosis input may be determined based on verification of one or more facts (e.g. for science subject learning) provided in the user feedback.

The specified speech highlights may be audio cues to aid the user in the completion or correction of the learning task.

The differentiated speech highlighting mask may be configured according to one or more affective settings comprising:
an instructive and/or encouraging mode for specifying speech highlights according to iambic meter;
a delightful and/or joyful mode for specifying speech highlights according to spondaic meter;
a reproachful mode for specifying speech highlights according to trochaic meter; and
a peremptory mode for specifying speech highlights according to dactylic meter.

An apparatus for generating one or more differentiated oral prompt for learning, wherein the apparatus comprises a processor for executing instructions in a memory to control the apparatus to:
(a) present a learning task to a user on a display;
(b) receive user feedback to the learning task;
(c) determine a diagnosis input based on the user feedback;
perform a diagnosis, using a prompt generation model, on the diagnosis input to generate a differentiated oral prompt and a differentiated speech highlighting mask associated with the differentiated oral prompt, wherein the differentiated speech highlighting mask include data indicative of prosodic control;
input the differentiated oral prompt and the differentiated speech highlighting mask to a Text-to-Speech module with prosody control to generate speech signals for reading out the differentiated oral prompt with speech highlights specified in the differentiated speech highlighting mask; and
convert the speech signals into a format for reading out the differentiated oral prompt with the specified speech highlights through an audio device.

In the present disclosure, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of examples, embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method for generating one or more differentiated oral prompt for learning, the method comprising:
(a) presenting a learning task to a user on a display;
(b) receiving user feedback to the learning task;
(c) determining a diagnosis input based on the user feedback;
(d) performing a diagnosis, using a prompt generation model, on the diagnosis input to generate a differentiated oral prompt and a differentiated speech highlighting mask associated with the differentiated oral prompt, wherein the differentiated speech highlighting mask include data indicative of prosodic control;
(e) inputting the differentiated oral prompt and the differentiated speech highlighting mask to a Text-to-Speech module with prosody control to generate speech signals for reading out the differentiated oral prompt with speech highlights specified in the differentiated speech highlighting mask; and
(f) converting the speech signals into a format for reading out the differentiated oral prompt with the specified speech highlights through an audio device.

2. The method of claim 1, the method comprising: performing prosody control at word level, character level, or phrase level of the differentiated oral prompt.

3. The method of claim 2, the method comprising:
using a speech recognition model to achieve temporal alignment of the differentiated oral prompt with speech highlights at the word level, character level, or phrase level, wherein the speech recognition model is a model trained by machine learning.

4. The method of claim 3, wherein information relating to the temporal alignment and the speech highlights are inputted to a digital signal processor (DSP) to generate the speech signals according to pitch, tempo and/or volume information specified in the speech highlights.

5. The method of claim 3, wherein the speech recognition model is configured to use short-time Fourier Transform (STFT) to segment the speech signals from the Text to Speech module into a first series of frames, wherein each frame corresponds to the spectral characteristic of an individual piece of utterance.

6. The method of claim 5, wherein the speech recognition model is used and the first series of frames is associated with the information relating to temporal alignment, wherein during temporal alignment, prosodic parameters of at least one part of the first series of frames are modified based on speech highlights specified in the differentiated speech highlighting mask to form a second series of frames.

7. The method of claim 6, wherein the second series of frame are processed by an inverse short-time Fourier Transform (ISTFT) to produce the speech signals for converting into the format for reading out through the audio device.

8. The method of claim 1, wherein the prompt generation model is a model trained by machine learning, and each differentiated oral prompt is specific to the learning task presented to the user.

9. The method of claim 1, the method comprising:
checking the diagnosis input to determine whether differentiated oral prompt is required for the learning task prior to commencement of step (e).

10. The method of claim 1, the method comprising:
presenting a visual cue on the display to the user to aid in the completion or correction of the learning task.

11. The method of claim 10, wherein the visual cue is displayed in text format and a part of the displayed text is highlighted according to the differentiated speech highlighting mask, wherein the part of text is displayed in the form of capitalized alphabets, bold, underline, italic, and/or a colour different from the rest of the text.

12. The method of claim 1, wherein the diagnosis input is determined based on evaluation of speech in the user feedback.

13. The method of claim 1, wherein the diagnosis input is determined based on a result obtained from error source detection in the user feedback.

14. The method of claim 1, wherein the diagnosis input is determined based on verification of one or more facts provided in the user feedback.

15. The method of claim 1, wherein the specified speech highlights are audio cues to aid the user in the completion or correction of the learning task.

16. The method of claim 1, wherein the differentiated speech highlighting mask is configured according to one or more affective settings comprising:
an instructive and/or encouraging mode for specifying speech highlights according to iambic meter;
a delightful and/or joyful mode for specifying speech highlights according to spondaic meter;
a reproachful mode for specifying speech highlights according to trochaic meter; and
a peremptory mode for specifying speech highlights according to dactylic meter.

17. An apparatus for generating one or more differentiated oral prompt for learning, wherein the apparatus comprises a processor for executing instructions in a memory to control the apparatus to:
present a learning task to a user on a display;
receive user feedback to the learning task;
determine a diagnosis input based on the user feedback;
perform a diagnosis, using a prompt generation model, on the diagnosis input to generate a differentiated oral prompt and a differentiated speech highlighting mask associated with the differentiated oral prompt, wherein the differentiated speech highlighting mask include data indicative of prosodic control;
input the differentiated oral prompt and the differentiated speech highlighting mask to a Text-to-Speech module with prosody control to generate speech signals for reading out the differentiated oral prompt with speech highlights specified in the differentiated speech highlighting mask; and
convert the speech signals into a format for reading out the differentiated oral prompt with the specified speech highlights through an audio device.
